(19) United States
(12) Patent Application Publication
(10) Pub. No.: US 2023/0219052 A1
(43) Pub. Date: Jul. 13, 2023

(54) MICROWAVE PLASMA SYSTEM FOR EFFICIENTLY PRODUCING NITRIC ACID AND NITROGEN FERTILIZERS

(71) Applicant: Nitricity, Inc., San Francisco, CA (US)

(72) Inventors: Joshua M. MCENANEY, San Francisco, CA (US); John A. SCHWALBE, Redwood City, CA (US); Sreekumar CHOCKALINGAM, Freemont, CA (US); Nicolas H. PINKOWSKI, San Francisco, CA (US)

(21) Appl. No.: 18/095,736

(22) Filed: Jan. 11, 2023

Related U.S. Application Data
(60) Provisional application No. 63/298,803, filed on Jan. 12, 2022.

(51) Int. Cl. B01J 19/12; B01J 19/24; C01B 21/40; C05C 5/00; C05G 5/23; B01D 53/18; B01D 53/14; B01D 53/56; B01D 53/78

(52) U.S. Cl. CPC B01J 19/126; B01J 19/245; C01B 21/40; C05C 5/00; C05G 5/23; B01D 53/185; B01D 53/1456; B01D 53/56; B01D 53/78; B01J 2219/0896; B01J 2219/0869; B01J 2219/0875; B01J 2219/1269; B01D 2252/103

(57) ABSTRACT

A microwave-plasma system for generating fixed-nitrogen products comprises a microwave generator operably coupled with a gas chamber where the microwave generator provides microwave power to the gas chamber. The system further includes a source of gas, which may be for example oxygen, nitrogen and/or air, operably coupled with the plasma chamber. The microwave power produces a plasma of the gas within the chamber. The system further includes an absorber unit fluidically connected to the gas chamber to capture product from the plasma in the gas chamber. The captured product may include fixed nitrogen gaseous products.

### CROSS-REFERENCE TO RELATED APPLICATION

This application is related to and claims priority under 35 U.S.C. § 119(e) from U.S. patent application Ser. No. 63/298,803 filed Jan. 12, 2022, titled “A MICROWAVE PLASMA SYSTEM FOR EFFICIENTLY PRODUCING NITRIC ACID AND NITROGEN FERTILIZERS,” the entire contents of which is incorporated herein by reference for all purposes.

### TECHNICAL FIELD

Embodiments of the present invention generally relate to a plasma system for fixing nitrogen and capturing fixed nitrogen products. More specifically, the present invention relates to a microwave-based system and method for producing plasma-nitrogen fixation where the gaseous fixed nitrogen may be captured to form liquid and solid chemical and fertilizer products.

### BACKGROUND AND INTRODUCTION

Industrial plasma nitrogen oxidation via the Birkeland-Eyde process was the premier nitrogen fixation method over a century ago, until the emergence of the Haber-Bosch process for ammonia synthesis. The Haber-Bosch process, however, is heavily dependent on fossil fuels and results in excessive carbon dioxide equivalent (CO₂ eq) emissions. Conversely, plasma-based processes are highly amenable to electrification and advancements in materials science, plasma physics, chemical engineering, and power electronics have led to a renewed interest in developing efficient plasma systems. Additionally, as renewable energy becomes cost-effective, systems and methods able to electrify chemical production, such as plasma processes, are increasingly attractive.

In the Birkeland-Eyde process, thermal electrical arcs are created that react nitrogen with oxygen to create gas-phase oxidized-nitrogen species, which are then reacted with water to produce nitric acid. Nitric acid may be used as a source of nitrate for nitrogen-based fertilizers. However, the thermal plasmas used have limited nitrogen-fixation efficiencies. Thermal arcs are also destructive to electrodes and not optimal for efficient production of oxidized-nitrogen species. Non-thermal plasmas have shown promise to improve energy efficiency of nitrogen fixation over that of thermal arcs. Investigators have explored nitrogen fixation using gliding arcs, dielectric-barrier discharge, corona discharge, radio-frequency plasmas, and others, with microwave plasmas being among the most promising. Under certain conditions, microwave-generators can produce non-thermal plasmas that react nitrogen with oxygen to create gas-phase oxidized-nitrogen species. In these plasma reactors, oxidizing nitrogen can also produce corrosive and oxidizing chemicals such as nitric acid, ozone, and nitrous oxides, which need to be considered when handling the products and byproducts. There are also physical and chemical conditions to consider and design for in order to most efficiently produce the desirable chemical product and eliminate potential byproducts.

It is with these observations in mind, among others, that aspects of the present disclosure were conceived.

### SUMMARY

One aspect of the present disclosure is related to a microwave-plasma system for generating fixed-nitrogen products comprising a power supply configured to power a microwave generator, a microwave generator configured to generate a plasma, a gas chamber for plasma production, and an absorber unit fluidically connected to the gas chamber for product capture.

In another aspect, a microwave-plasma system for generating fixed-nitrogen products comprises a microwave generator operably coupled with a gas chamber where the microwave generator provides microwave power to the gas chamber. The system further includes a source of gas, which may be oxygen, nitrogen and/or air, operably coupled with the plasma chamber. The microwave power produces a plasma of the gas within the chamber. The system further includes an absorber unit fluidically connected to the gas chamber to capture product from the plasma in the gas chamber. The captured product may include fixed nitrogen gaseous products.

The microwave generator may include a magnetron head with a resonant cavity or a solid-state microwave generator. In various examples, the microwave generator may be operably coupled with a waveguide, which may be a tapered waveguide, which in turn is operably coupled with the gas chamber.

The gas chamber may include a tubular member, which may be a quartz tube. The plasma generator may be operably coupled with a waveguide to direct and tune the microwaves for the chamber. In one example, the waveguide defines a hole and is further operably coupled with the tubular member at the hole to orient the waveguide perpendicular to a flow of gas in the tubular member thereby microwaves interface with a cross section of the flow of gas. The system may further include a power supply operably coupled with the microwave generator, and the power supply may provide pulsed or continuous power to the microwave generator.

The system may further include an air separation unit delivering a stream of nitrogen and oxygen to the gas chamber. The system may also include an oxidation chamber oxidizing gaseous fixed-nitrogen products from the plasma chamber. The oxidation chamber may be coupled with the absorber unit and provide oxidized fixed-nitrogen products thereto.

In arrangements, the absorber unit contains a salt or a basic compound to produce nitrate salts or the absorber unit contains water or hydrogen peroxide to produce nitric acid. In another arrangement, the absorber unit captures gaseous fixed-nitrogen products as liquid fixed-nitrogen products. In various examples, the absorber unit comprises one or more of a bubble-absorber column, a plate-absorber column, or a liquid-shower column.

The system may further include an ignition system operably coupled with the plasma chamber where the ignition system ignites the plasma. In one specific example, the ignition system comprises a retractable conductive member with a non-conductive sheath. In other examples, the ignition system comprises a laser-ignition system, a noble-gas-injection-ignition system, a spark-ignition system, or an electric-field-pulse-ignition system.

Another aspect of the present disclosure involves a method for producing fixed-nitrogen products by microwave plasma oxidation of nitrogen. The method involves generating and propagating microwaves into a plasma-generation chamber and feeding a gas comprising nitrogen and oxygen into the plasma-generation chamber in the presence of the microwaves thereby generating a plasma, wherein the plasma oxidizes the gas to produce oxidized nitrogen species. In one example of the method, a conversion of nitrogen in the gas to oxidized nitrogen species is between about 0% to about 10%. In various examples, the oxidized nitrogen species comprises one or more of nitric oxide, nitrogen dioxide, nitrous oxide, dinitrogen dioxide, nitric acid, and nitrous acid.

The method may further involve contacting the oxidized nitrogen species with a liquid. In various examples, a concentration of nitrogen in the gas is between about 5% to about 85%, and a concentration of oxygen in the gas is between about 5% to about 85%. In various examples, a fraction of the nitric oxide in the oxidized nitrogen species is between about 40% to about 80% by volume. The nitric acid may be captured with an efficiency of greater than about 80%. The gas may be air and the gas may include argon.

Another aspect of the present disclosure involves a system for producing fixed nitrogen products by microwave plasma oxidation of nitrogen. The system includes a gas inlet in communication with a plasma-generation chamber and a microwave generator in communication the plasma-generation chamber, which generator produces microwaves to generate a plasma from a gas (e.g., oxygen and nitrogen or air) supplied to the plasma-generation chamber by way of the gas inlet. The system further includes a heat exchanger in fluid communication with the plasma-generation chamber and an absorber in fluid communication with the heat exchanger where the absorber captures oxidized nitrogen species in a liquid. The system further includes a liquid-nitrate outlet in communication with the absorber.

The system may further include an oxidation chamber in communication with the plasma-generation chamber. The oxidation chamber may further be in fluid communication with the heat exchanger, with the oxidation chamber oxidizing fixed nitrogen. The oxidized nitrogen species may comprise any combination of nitric oxide, nitrogen dioxide, nitrous oxide, dinitrogen dioxide, nitric acid, and nitrous acid.

In various examples, the systems described herein may include recycle loops. In one example, the system may include a recycle loop in fluid communication between the heat exchanger and the plasma-generation chamber. In another example, a recycle loop may be in fluid communication between an input and an output of the absorber. In such an example, the recycle loop recycles nitric oxide and nitrogen dioxide through the absorber. A recycle loop may also recycles reactants, N₂O, or argon to the plasma-generation chamber.

These and other aspects of the present disclosure are described in further detail below.

### BRIEF DESCRIPTION OF THE DRAWINGS

The foregoing and other objects, features, and advantages of the present disclosure set forth herein should be apparent from the following description of particular embodiments of those inventive concepts, as illustrated in the accompanying drawings. The drawings depict only typical embodiments of the present disclosure and, therefore, are not to be considered limiting in scope.

FIG. 1 is a block diagram showing an exemplary conception for producing and capturing fixed nitrogen products using a microwave plasma system.

FIG. 2 is an embodiment tunable microwave plasma reactor system for capturing liquid nitrate products.

FIG. 3 is an embodiment of a multi-plasma microwave reactor system for capturing liquid nitrate products.

FIG. 4 is a flowchart of a method for operating a microwave system to produce fixed-nitrogen products.

FIG. 5 is a diagram illustrating an example of a computing system which may be used in implementing embodiments of the present disclosure.

### DETAILED DESCRIPTION

Aspects of the present disclosure involve a microwave plasma system for use in nitric acid or nitrate-based fertilizer production. Microwaves are capable of producing a wide array of plasma conditions, many of which result in excessive and wasted heat energy. However, microwave plasma devices can be designed, tuned, and optimized to provide a favorable combination of electric field and temperature for efficient oxidation of nitrogen. A well-tuned microwave system may also be designed to be cost-effective. Following the challenging initial oxidation step, an array of well-controlled and engineered components is beneficial to apply conditions where oxidized nitrogen species can be efficiently converted to and trapped as a nitric acid or nitrate product. Provided herein is a microwave system and method with the features, materials, and properties to overcome these challenges, among others.

In some example implementations discussed herein, a microwave plasma system may include a microwave plasma gas chamber (or microwave reactor) that contains a microwave induced plasma wherein nitrogen and oxygen may be fed to produce oxidized nitrogen species. Oxidized nitrogen species may include nitric oxide, nitrogen dioxide, nitrous oxide, dinitrogen dioxide, nitric acid, nitrous acid, among other oxygen-containing nitrogen compounds. Power is provided to a microwave generator, which generates microwaves sufficient to initiate and sustain a plasma forming the oxidized nitrogen species in the microwave plasma gas chamber.

The oxidized nitrogen species may be carried in the gas phase to an oxidation chamber where partially oxidized nitrogen species can be converted to further oxidized nitrogen species within the system. Particularly, nitric oxide, which has low solubility in water, is converted to nitrogen dioxide, which has high solubility and readily converts to nitric acid in water. In some implementations, gas from the oxidation chamber may be cooled in a heat exchanger before being directed toward an absorber unit that absorbs oxidized nitrogen species in the liquid form. In one example implementation, this absorber unit contains water that is used to convert nitrogen dioxide into nitric acid as a product. In another example implementation, the absorber unit may contain a salt or basic compound, such as potassium chloride, potassium hydroxide, sodium carbonate, calcium carbonate, calcium hydroxide, or phosphate rock, among others, to produce nitrate salts as a product. These features, among others, may be used, alone or in various combinations, in a microwave plasma system to efficiently produce nitric acid, nitrate salts, and more generally nitrate-based fertilizers. After such products are formed, a system may include various devices to concentrate or dry them such as distillation and a rotary drying drum.

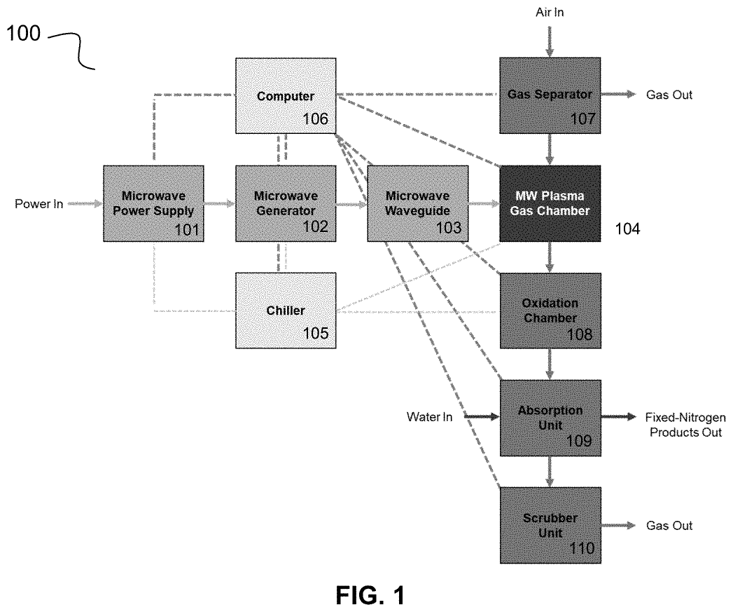

FIG. 1 is a block diagram illustrating an example microwave plasma system 100 for producing and capturing fixed nitrogen products. In the example system, a microwave power supply 101 provides power at a voltage between 0-100 kV, and in a specific arrangement between 0.1-10 kV, to a microwave generator 102. Microwave power supply may intake power from an AC or DC grid or intermittent power source.

The microwave generator 102 may convert power from the power supply into a microwave signal in the range of 30 MHz to 300 GHz. In specific examples, the microwave generator signal frequency may be 2.45 GHz or 915 MHz, due to standardization of microwave components and applications at these frequencies to save cost, although other frequencies may be used in example embodiments discussed herein. In some embodiments, the microwave generator signal frequency may be between about 0.03 GHz to about 3.00 GHz, may be about 0.03 GHz to about 0.04 GHz, about 0.04 to about 0.05 GHz, about 0.05 GHz to about 0.06 GHz, 0.06 GHz to about 0.07 GHz, about 0.07 GHz to about 0.08 GHz, about 0.08 GHz to about 0.09 GHz, about 0.09 GHz to about 0.1 GHz, about 0.1 GHz to about 0.2 GHz, about 0.2 GHz to about 0.3 GHz, about 0.3 GHz to about 0.4 GHz, about 0.4 GHz to about 0.5 GHz, about 0.5 GHz to about 0.6 GHz, about 0.6 GHz to about 0.7 GHz, about 0.7 GHz to about 0.8 GHz, about 0.8 GHz to about 0.9 GHz, about 0.9 GHz to about 1 GHz, about 1 GHz to about 2 GHz, or about 2 GHz to about 3 GHz. In some additional embodiments, the microwave generator signal frequency may be about 0.03 GHz to about 0.05 GHz, about 0.03 GHz to about 0.06 GHz, about 0.03 GHz to about 0.07 GHz, about 0.03 n GHz to about 0.08 GHz, about 0.03 GHz to about 0.09 GHz, about 0.03 GHz to about 0.1 GHz, about 0.03 GHz to about 0.2 GHz, about 0.03 GHz to about 0.3 GHz, about 0.03 GHz to about 0.4 GHz, to about 0.03 GHz to about 0.5 GHz, about 0.03 GHz to about 0.6 GHz, about 0.03 GHz to about 0.7 GHz, about 0.03 GHz to about 0.8 GHz, about 0.03 GHz to about 0.9 GHz, about 0.03 GHz to about 1 GHz, about 0.03 GHz to about 2 GHz, about 0.04 GHz to about 3 GHz, about 0.05 GHz to about 3 GHz, about 0.06 GHz to about 3 GHz, about 0.07 GHz to about 3 GHz, about 0.08 GHz to about 3 GHz, about 0.09 GHz to about 3 GHz, about 0.1 GHz to about 3 GHz, about 0.2 GHz to about 3 GHz, about 0.3 GHz to about 3 GHz, about 0.4 GHz to about 3 GHz, about 0.5 GHz to about 3 GHz, about 0.6 GHz to about 3 GHz, about 0.7 GHz to about 3 GHz, about 0.8 GHz to about 3 GHz, about 0.9 GHz to about 3 GHz, or about 1 GHz to about 3 GHz.

The microwave generator 102 is connected to a MW- (microwave-) plasma-gas chamber 104 by a microwave waveguide 103. A microwave waveguide 103 contains and propagate microwaves to the MW-plasma-gas chamber 104 and minimizes reflected power. Minimizing reflected power helps ensure that power is used to generate and sustain the plasma and not lost to impedance, among other benefits. A microwave waveguide 103 may contain components to tune, concentrate the microwave field, and/or propagate surface waves into a gas plasma, which may be a well-controlled gas plasma, such as a 3-stub tuner and a surfaguide launcher (tapered waveguide before or surrounding the plasma chamber). A “well-controlled gas plasma” refers to a gas plasma having at least a minimum vortex flow measured in 1 pm per diameter of the plasma tube. As discussed below, in some arrangements, gas inlets into the chamber, which may be a tubular, are positioned to initiate a vortex flow. In some embodiments, a tuner may be automated to accept variable input power and adjust to variations in input power. Without wishing to be bound by theory, a waveguide-based system may be favorable because of their relative simplicity, easy design, high power handling capacity and low cost. Additionally, tapered waveguides such as surfaguide launchers may locally excite and guide microwaves to then propagate along the plasma itself, creating a plasma sustaining effect where long columns of plasma may be created.

Waveguides may be sized according to the microwave generator signal frequency using methods known to those having skilled in the art. In a non-limiting example wherein the microwave generator signal frequency is 2.45 GHz, the waveguide may be WR-340, which has a width of 3.40 inches and a height of 1.70 inches, and which may propagate frequencies between about 2.2 GHz and about 3.3 GHz. In a non-limiting example wherein the microwave generator signal frequency is 915 MHz, the waveguide may be WR-1000, which has a width of 9.975 inches and a height of 4.875 inches, and which may propagate frequencies between about 750 MHz and about 1.1 GHz.

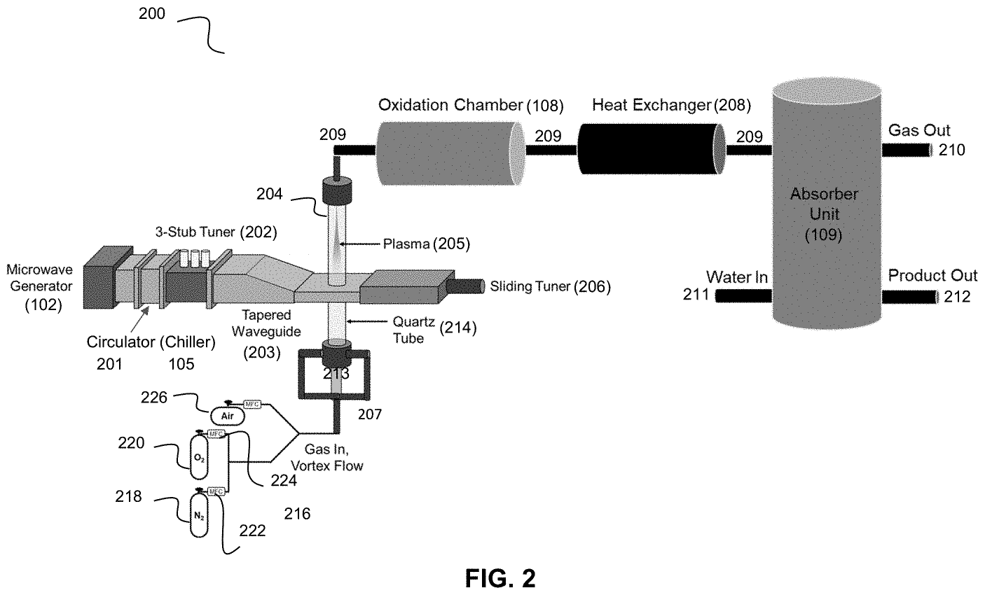

The MW-plasma-gas chamber 104, which may be or include a tubular chamber, may contain a region where gas can be excited to form a plasma state. This region may experience a strong electric field from microwave waveguide 103 withstand intense temperatures (on the order of hundreds or thousands of degrees) once the plasma is ignited. The strength of the electric field may be measured via electromagnetic field sensors or indirectly by measuring other features (e.g., power, plasma size, etc.). The electric field is typically strongest at the center of the longest dimension of the waveguide (e.g., where the plasma chamber tube is coupled with the waveguide). A strong electric field may be used to indicate a concentrated microwave field. In some example embodiments discussed herein, a concentrated microwave field may be created by providing a waveguide having a hole in its path to allow microwaves to interface with a cross-section of gas, wherein the gas flows perpendicular to the waveguide orientation. As shown in FIG. 2, with gas entering a lower (first) portion of the quartz tube, the plasma is ignited where the gas flows upward and perpendicular to the microwaves being propagated through the waveguide, and the plasma is in the tubular member above the waveguide. The orientation may be changed such that gas flows downward, to the side, etc., and the upward flow shown is simply for purposes of illustration. Generally, the minimum strength of the electric field required to ignite an air plasma at atmospheric pressure may be about 3.3 kV/cm. This value may be lower as process parameters and equipment vary, such as using an argon ignition system. In steady state operation, the field may be substantially lower as existing ionization allows for stable plasma operation.

The region of plasma generation may be isolated from a cavity of the microwave waveguide by a dielectric barrier containing the gas.

In some embodiments, one or more of a chiller 105 may be connected to any of the components in the microwave plasma system to provide active cooling either to protect system components from damage and/or to increase system efficiency as described in some cases below.

A computer 106, or more generally any of a variety of different types of computing elements, a controller, or other processing device, alone or in combinations, may be used to control, operate, and coordinate the functions of subcomponents, valves, and sensors in the microwave plasma system and is also described in further detail below.

In various embodiments, the system 100 includes a gas input system where various gases are supplied to the plasma chamber. The gas input system may include distinct gas flow paths and processing for the various gases that will be processed, and to ensure that the desired blend of gases is supplied to the chamber. In the embodiment illustrated in FIG. 1, gas input into the system may be air pumped through gas separator 107 and into the gas flow region of MW-plasma-gas chamber 104. Gas separator 107 may change the composition of gas flowing into chamber 104 for plasma ionization. In some embodiments the initial gas composition of the gas feed to chamber 104 may contain over 5% oxygen and over 5% nitrogen, with a preferable range of 15-85% oxygen and 15-85% nitrogen, and a more preferable range of 50-80% oxygen and 20-50% nitrogen.

In some embodiments, the amount of oxygen (O₂) in the initial gas composition may be about 5% to about 10% about 10% to about 15%, about 15% to about 20%, about 20% to about 25%, about 25% to about 30%, about 30% to about 35%, about 35% to about 40%, about 40% to about 45%, about 45% to about 50%, about 50% to about 55%, about 55% to about 60%, about 60% to about 65%, about 65% to about 70%, about 70% to about 75%, about 75% to about 80% or about 80% to about 85%. In some additional embodiments, the amount of oxygen in the initial gas composition may be about 5% to about 15%, about 5% to about 20%, about 5% to about 25%, about 5% to about 30%, about 5% to about 35%, about 5% to about 40%, about 5% to about 45%, about 5% to about 50%, about 5% to about 55%, about 5% to about 60%, about 5% to about 65%, about 5% to about 70%, about 5% to about 75%, about 5% to about 80%, about 10% to about 85%, about 15% to about 85%, about 20% to about 85%, about 25% to about 85%, about 30% to about 85%, about 35% to about 85%, about 40% to about 85%, about 45% to about 85%, about 50% to about 85%, about 55% to about 85%, about 60% to about 85%, about 65% to about 85%, about 70% to about 85%, or about 75% to about 80%.

In some embodiments, the amount of nitrogen (N₂) in the initial gas composition may be about 5% to about 10% about 10% to about 15%, about 15% to about 20%, about 20% to about 25%, about 25% to about 30%, about 30% to about 35%, about 35% to about 40%, about 40% to about 45%, about 45% to about 50%, about 50% to about 55%, about 55% to about 60%, about 60% to about 65%, about 65% to about 70%, about 70% to about 75%, about 75% to about 80% or about 80% to about 85%. In some additional embodiments, the amount of nitrogen in the initial gas composition may be about 5% to about 15%, about 5% to about 20%, about 5% to about 25%, about 5% to about 30%, about 5% to about 35%, about 5% to about 40%, about 5% to about 45%, about 5% to about 50%, about 5% to about 55%, about 5% to about 60%, about 5% to about 65%, about 5% to about 70%, about 5% to about 75%, about 5% to about 80%, about 10% to about 85%, about 15% to about 85%, about 20% to about 85%, about 25% to about 85%, about 30% to about 85%, about 35% to about 85%, about 40% to about 85%, about 45% to about 85%, about 50% to about 85%, about 55% to about 85%, about 60% to about 85%, about 65% to about 85%, about 70% to about 85%, or about 75% to about 80%.

In other embodiments air may be used directly (e.g., without processing through a gas separator). Without wishing to be bound by theory, air may be favorable because it may not require further purification; however, using air may introduce impurities or may decrease efficiency. For example, CO₂ in air may coat the plasma chamber with conductive carbon over time, and thus CO₂ may need to be filtered or otherwise removed. In additional embodiments, argon may be added to the initial gas composition because argon readily ignites and sustains a plasma. In some embodiments additional gas separators may provide other gases to other components in the microwave system or may recirculate gases from product streams to reactant streams. Gases recirculated from product streams (e.g., from the gas separator 107, the absorption unit 109 or the scrubber unit 112) to reactant streams (e.g., into a gas separator or the gas separator 107) may be performed to improve cost effectiveness, to increase oxidation of reactants, to improve purity of product streams, and/or to destroy products harmful to the environment. In some embodiments, the gases recirculated from product streams to reactant streams may include argon, nitrogen, oxygen, N₂O, and ozone. In some aspects, the product gases may be recirculated after cooling to protect gas separation equipment from excess heat, and hence a chiller or other form of cooling may be in the recirculation path between a product stream or gas out stream and reactant stream or other stream.

In certain embodiments, MW-plasma-gas chamber 104 contains a plasma which converts an amount of nitrogen and oxygen from the gas input system (e.g., from gas separator 107) into oxidized nitrogen species. This conversion rate may be between 0-10% or more of the gas input. In some aspects, the conversion may be 0-1%, 1-2%, 2-3%, 3-4%, 4-5%, 5-6%, 6-7%, 7-8%, 8-9%, or 9-10%. In still further aspects, the conversion may be 0-2%, 0-3%, 0-4%, 0-5%, 0-6%, 0-7%, 0-8%, 0-9%, 1-10%, 2-10%, 3-10%, 4-10%, 5-10%, 6-10%, 7-10%, or 8-10%. In some embodiments, gas containing the oxidized nitrogen species is routed through an oxidation chamber 108, wherein fixed nitrogen may be further oxidized to promote the formation of nitrogen dioxide by time or surfaces to promote the chemical reaction. In some embodiments, the rate of conversion of nitric oxide to nitrogen dioxide may be about 10-100%. In some aspects, the conversion may be 10-20%, 20-30%, 30-40%, 50-60%, 60-70%, 70-80%, 80-90%, or 90-100%. In still further aspects, the conversion may be 10-30%, 10-40%, 10-50%, 10-60%, 10-70%, 10-80%, 10-90%, or 10-100%. In some embodiments, catalysts may be used to promote oxidation of nitric oxide to nitrogen dioxide. In some aspects, the catalysts may include palladium, platinum, or platinum ceria. Oxidation chamber 108 may be fluidically connected to the output of MW-plasma-gas chamber 108 and may include or may be succeeded by a heat exchanger to cool the effluent gas containing oxidized nitrogen species.

In certain embodiments an absorption unit 109 may be fluidically connected to receive the oxidized nitrogen species containing nitrogen dioxide. In embodiments, an absorption unit 109 contains at least water. Water may react with nitrogen dioxide to form nitrates in solution. Absorber 109 may intake water as an absorber and output aqueous fixed-nitrogen products. The fixed nitrogen products may contain nitric acid or other nitrate-based fertilizers (such as potassium nitrate, calcium nitrate, nitrophosphates, sodium nitrate, ammonium nitrate, urea-ammonium-nitrate, calcium-ammonium-nitrate, nitric acid, micronutrient nitrates, or mixtures thereof). In some embodiments, the absorber unit may be one or more of bubble-absorber columns, plate-absorber columns, liquid-shower columns, or a combination of these. Excess gases may be purged or scrubbed from the system from any part of the system, through scrubber unit 110.

In some embodiments, the system 100 may include a scrubber unit 110, which may scrub NOx (NO, NO₂, N₂O, or other NₓO_{y} chemicals) or acidic (HNO3, HONO) components from a waste gas stream (e.g., a stream from the absorption unit). The further processing of the waste gas stream may be for protecting the environment, and the scrubber may be in the form of a catalytic converter or liquid reactor to capture and remove the NOx or acidic components. In some embodiments, the scrubber may use selective catalytic reduction (SCR) to remove the NOx. In other embodiments, a scrubber may be an alkaline chemical scrubber.

With the various possible arrangements possible relative to the description of FIG. 1, which will also apply to discussion of the other embodiments, any number of valves and connecting components may be used to connect components of the microwave plasma system, realized the described gas and product paths, connect with post processing systems, form recirculation paths, and the like.

In some embodiments, the fraction of nitric oxide in the oxidized nitrogen species may be about 40% to about 80% by volume. In some additional embodiments, the fraction of nitric oxide in the oxidized nitrogen species may be about 40% to about 45%, about 45% to about 50%, about 50% to about 55%, about 55% to about 60%, about 65% to about 70%, about 70% to about 75%, or about 75% to about 80% by volume. In still further embodiments, the fraction of nitric oxide in the oxidized nitrogen species may be about 40% to about 50%, about 40% to about 55%, about 40% to about 60%, about 40% to about 65%, about 40% to about 70%, about 40% to about 75%, about 45% to about 80%, about 50% to about 80%, about 55% to about 80%, about 60% to about 80%, about 65% to about 80%, or about 70% to about 80% by volume. In still further embodiments, the fraction of nitric oxide in the oxidized nitrogen species may be about 40%, 45%, 50%, 55%, 60%, 65%, 70%, 75%, or about 80% by volume.

In some embodiments, nitric acid may be captured from the product stream with an efficiency of greater than about 80%. In some additional embodiments, nitric acid may be captured from the product stream with an efficiency of about 80% to about 85%, about 85% to about 90%, about 90% to about 95%, or about 95% to about 99.9%. In further embodiments, nitric acid may be captured from the product stream with an efficiency of about 80% to about 90%, about 80% to about 95%, about 80% to about 99.9%, about 85% to about 99.9%, about 90% to about 99.9%, or about 95% to about 99.9%. In still further embodiments, the nitric acid may be captured from the product stream with an efficiency of about 80%, 81%, 82%, 83%, 84%, 85%, 86%, 87%, 88%, 89%, 90%, 91%, 92%, 93%, 94%, 95%, 96%, 97%, 98%, 99%, or about 99.9%.

The efficiency of producing oxidized nitrogen species may be described as the level of plasma energy consumed per pound of nitrogen supplied (kWh/lb N). In some embodiments, the efficiency of producing oxidized nitrogen species may be less than about 15 kWh/lb N. In some embodiments, the efficiency of producing oxidized nitrogen species may be less than about 15 kWh/lb N, less than about 10 kWh/lb N, or less than about 5 kWh/lb N. In some additional embodiments, the efficiency of producing oxidized nitrogen species may be about 15 kWh/lb N, about 14 kWh/lb N, about 13 kWh/lb N, about 12 kWh/lb N, about 11 kWh/lb N, about 10 kWh/lb N, about 9 kWh/lb N, about 8 kWh/lb N, about 7 kWh/lb N, about 6 kWh/lb N, about 5 kWh/lb N, or less than about 5 kWh/lb N.

The efficiency of producing oxidized nitrogen species may also be considered in the context of producing nitrate fertilizers. In some embodiments, the efficiency of producing nitrate fertilizers using the process of the present disclosure may be about 5 kWh/lb N to about 25 kWh/lb N. In some additional embodiments, the efficiency of producing nitrate fertilizers using the process of the present disclosure may be about 5 kWh/lb N to about 10 kWh/lb N, about 10 kWh/lb N to about 15 kWh/lb N, about 15 kWh/lb N to about 20 kWh/lb N, or about 20 kWh/lb N to about 25 kWh/lb N. In further embodiments, the efficiency of producing nitrate fertilizers using the process of the present disclosure may be about 5 kWh/lb N to about 15 kWh/lb N, about 5 kWh/lb N to about 20 kWh/lb N, about 10 kWh/lb N to about 25 kWh/lb N, or about 15 kWh/lb N to about 25 kWh/lb N. In still further embodiments, the efficiency of producing nitrate fertilizers using the process of the present disclosure may be about 5 kWh/lb N, 6 kWh/lb N, 7 kWh/lb N, 8 kWh/lb N, 9 kWh/lb N, 10 kWh/lb N, 11 kWh/Ib N, 12 kWh/Ib N, 13 kWh/Ib N, 14 kWh/Ib N, 15 kWh/lb N, 16 kWh/lb N, 17 kWh/lb N, 18 kWh/lb N, 19 kWh/lb N, 20 kWh/lb N, 21 kWh/lb N, 22 kWh/lb N, 23 kWh/lb N, 24 kWh/lb N, or about 25 kWh/lb N.

In a non-limiting example wherein the flow rate of the nitrogen and oxygen gas stream is about 50 slpm and the applied microwave power is about 1.28 kW, a product stream contains about 1.9% by volume oxidized nitrogen species. In another non-limiting example wherein the flow rate of the nitrogen and oxygen gas stream is about 30 slpm and the applied microwave power is about 1.28 kW, the product stream contains about 2.5% by volume oxidized nitrogen species.

One specific example of microwave plasma system 200 is illustrated in FIG. 2. The microwave plasma system 200 includes a microwave generator 101 that generates microwaves using power from a power supply. In various possible configurations, the microwave energy is coupled with a plasma chamber 204 by way of a circulator 201, a 3-stub tuner 202, a tapered waveguide 203 and a sliding tuner 206.

In one embodiment, the circulator 201 may be coupled between the 3-stub tuner and the microwave generator to protect the microwave generator from any reflected microwaves from a plasma load impedance mismatch. Generally speaking, the circulator transmits microwave power, e.g., a radio frequency microwave signal, unidirectionally from the microwave generator to the following component, which may be a 3-stub tuner. In one specific example, the circulator 201 may be a 3-port circulator, although other possible circulators such as a 4-port tuner are possible.

In some embodiments, a magnetron of the microwave generator may operate at about 0.5 kW to about 500 kW. In some aspects, the magnetron may operate at about 0.5 kW to about 1 kW, about 1 kW to about 5 kW, about 5 kW to about 10 kW, about 10 kW to about 50 kW, about 50 kW to about 100 kW, or about 100 kW to about 500 kW. In some examples, the magnetron may operate at about 6 kW. In some additional examples, the magnetron may operate at about 100 kW.

As noted above, microwave power may be coupled to the waveguide through a tuner, which may be a 3-stub tuner 202. The tuner is used to tune the shape and propagation of the microwave radiation through the waveguide, and/or for radio frequency impedance matching. In some embodiments, the shape of the microwave radiation may be sinusoidal. In some embodiments, the system may include a feedback loop applying a power set point for microwave generation. In some examples, the feedback loop for applying a power set point for microwave generation may adjust the power based on desirable power, available power from the grid, available power from an intermittent power source, or reflected power. In some examples, the feedback loop applying a power set point for microwave generation may minimize reflected power by adjusting the 3-stub tuner, wherein the reflected power is measured using an auto-tuner. In some examples, the feedback loop may operate by measuring reflected power, adjusting the 3-stub tuner, and remeasuring the reflected power. In such an example, the system may iterate toward minimizing reflected power. It should be noted that, in addition to or alternatively to reflected power, the system may use other measures such as forward power, impedance, return loss and the like. Since reflected power (or other parameters) may be influenced by the variations in the plasma, such iterations may be ongoing, done periodically, or intermittently. In an alternative, the system may include a match network to minimize any impedance mismatch caused from the plasma and the microwave power.

The tapered waveguide 203 concentrate (focuses) the microwave radiation toward the microwave-plasma-gas chamber 204. A waveguide may be made of a conductive material such as aluminum, copper and brass sized to propagate microwaves. In one embodiment, a plasma gas container 214 is part of the microwave gas chamber 204. The plasma gas container 204 may be a dielectric material such as a quartz or alumina tube. Plasma gas container 204 may contain a microwave-generated plasma 205. The plasma gas container may be tubular with an input and an output.

In the example system illustrated, a sliding tuner 206 may be located at the end of the waveguide and may be used to further tune the plasma waveform and reflected power to direct more or less microwave power into production of the plasma. The 3-stub tuner 202 and/or the sliding tuner 206 may be controlled, such as by the computing element 106, to automatically tune based on measured conditions, for example, to minimize the measured reflected power in the waveguide.

The system further includes a gas input system 216 that supplies gas to form the plasma in the plasma chamber. In one example, the gas input system is coupled with an input port to the tubular gas container. In the example illustrated, the gas input system includes a source of nitrogen 218 and a source of oxygen 220. The combination of gases supplied to the chamber to generate the plasma may be controlled through mass flow controllers (MFC) 222 and 224, or other form of valve, coupled to the respective sources and controlled from the computer to control the flow of gas from each source. In addition or alternatively, the gas input system may include a source of air 226 coupled with the input to the gas container and controlled by way of a MFC or other valve. The source of air may be coupled with an air separation unit that separates air into at least nitrogen and oxygen. In such an arrangement, the system may further control the amount of oxygen gas and nitrogen gas fed into the plasma chamber. In some examples, the air separation unit may further separate argon gas or other insert gases.

Generally speaking, the sources gas or gases is supplied to the plasma chamber. In one possible embodiment, there are at least two gas in ports 207 coupled with the gas container and arranged to generate a vortex flow in the plasma gas container 204. In the example shown, there are two ports coupled into a tubular member and positioned to inject the gas at an angle to generate a vortex. The tubular member is coupled with the tubular gas container and the vortex is thus also present in the gas container. A vortex flow may be beneficial for controlling and stabilizing a plasma, whereby the plasma can be generated and sustained closer or further from the walls of the plasma gas container 204. More generally, the vortex flow may be generated by providing one or more gas input ports on the gas-inlet side of the plasma containing tube, where gas input ports are offset and angled to create a cyclone of the input gas along the length of the tube toward the gas-output. This may further cool the walls, which may reduce damage and prolong the life of the chamber as the plasma gas can be very hot.

As illustrated in FIG. 2, feed gas (or gases) is fed into the tubular gas container, which may or may not be fed into the chamber to produce a vortex. Where the waveguide is coupled with the tubular member, microwave power is provided to ignite and sustain a plasma 205 within the chamber. The output 209 of the gas chamber may be coupled with an oxidation chamber 108 to produce oxidized nitrogen species.

In the system of FIG. 2, effluent from plasma gas chamber 204 proceeds to oxidation chamber 108. In some embodiments, the heat of the plasma may be used to encourage oxidation of nitrogen species in oxidation chamber 108. Heat from the gas effluent is removed in heat exchanger 208. Oxidation chamber 108, heat exchanger 208, and connecting conduits 209 may be made of materials resistant to corrosion by NOx and nitric-acid-containing gasses and condensates such as stainless steel, PVC, or corrosion-resistant-metal plated. Cooled effluent gas from heat exchanger 208 is fed to absorber unit 109 containing a liquid absorber fluid. In some embodiments absorber unit 109 may be a bubble column containing water from water inlet 211. In other embodiments, absorber unit 109 may be a shower or plate absorber containing a dissolved salt or alkaline material. Absorber unit 109 may be made of materials able to resist corrosion by NOx and nitric-acid-containing gases and liquids such as stainless steel or PVC. Absorber unit 109 may be connected to a number of gas and liquid ports and pumps to transport unabsorbed gases out of, for example, gas out port 210, and products out of, for example, product out port 212. These gases may be recycled or scrubbed depending on application requirements. In some embodiments, NO, NO₂, and N₂O may be recycled if not absorbed in the absorber unit 109. In some examples, the NO and NO₂ are recycled back through the absorber column. In some additional examples, N₂O is recycled to the plasma chamber. These liquid products may be concentrated, used as-is, or collected and prepared for further chemical or physical conversions.

The system may further include an ignition system 213 coupled with the input side of the plasma chamber. The ignition system may comprise a thin conductive metallic element with a high melting point and resistance less than 350 ohms. The conductive metallic element may include a surrounding porous sheath composed of a refractory material which protects the conductive element from contact with other parts of the reaction zone where the plasma is initiated in the chamber. The sheath may include pores or holes that allow for contact between the conductive element and the gas to be ignited. This conductive element may also be retractable so that it can be removed from the plasma zone to avoid thermal damage. The metallic element may be supported on a linear actuator, pneumatic actuator or cylinder, or other mechanism that inserts and retracts the metallic element. In one specific embodiment, the time to remove the conductive element is less than 0.01 second. In alternative embodiments an ignition system 213 may include a spark generator or laser to provide a spark or laser to increase the local temperature of gas in the gas chamber (e.g., tube 204) to initiate plasma ignition. A laser may be positioned and coupled with the gas chamber to focus in the middle of a gas stream. In further embodiments, a stream of easily ionized gas or noble gas such as argon may be applied through ignition system 213 or otherwise through a gas injection port to the plasma chamber to decrease the energy barrier for ignition. In still further embodiments, the ignition system 213 and/or the microwave generator may provide a pulse of MW-plasma power to increase the local field strength experienced by the gas in the MW-plasma chamber, causing ignition.

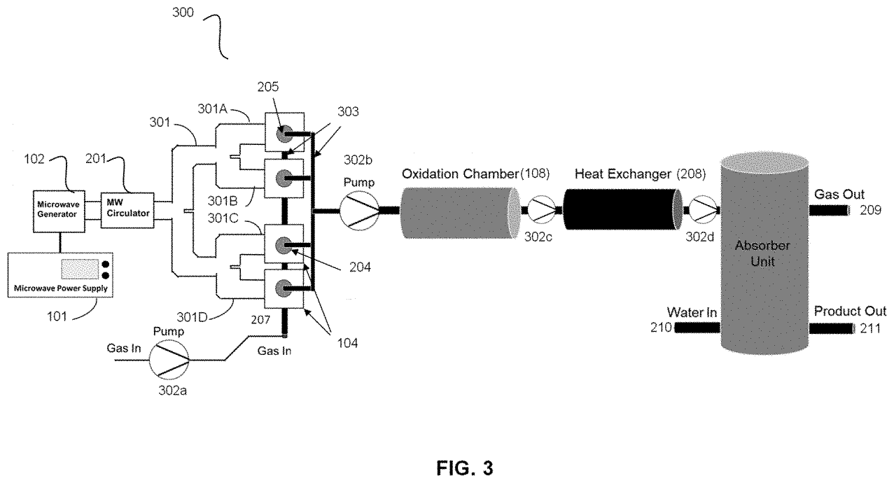

An alternative embodiment of the present disclosure is shown in FIG. 3. In this alternative, various components are consistent with the systems described relative to FIGS. 1 and 2. In contrast to the system of FIG. 2, the system of FIG. 3 includes a fixed waveguide 301 may propagate and focus microwaves of a specific power into a gas chamber. Fixed waveguide 301 may include a fixed conductive wall or rod positioned such that the forward microwave power is directed to drive plasma production and the reflected, reverse microwave power may be minimized under a desired operating condition. In one example, a rod is positioned along a centerline of the waveguide and optimally positioned within the waveguide based on specific characteristics of the plasma system. Stated differently, the fixed waveguide dimensions and/or rod position may be optimized to propagate microwave power under specific process conditions that are expected for a combination of feed gases and plasma properties. Like the system of FIG. 2, the system of FIG. 3 may also include a circulator 201. Alternatively, the waveguide 301 may include one of more of tuners, for example a 3-stub tuner 202 and/or a sliding tuner 206.

The fixed waveguide 301 may also include a narrow region to locally excite surface waves toward the plasma-gas chamber or tube 204. In the example of FIG. 3, the waveguide includes a relatively larger rectangular cross-sectional region that tapers to a relatively smaller rectangular cross-sectional region. In the example shown, the larger region tapers to the smaller region with a sloped wall, with the width of both regions being the same, and the sloped wall connecting a larger height of the larger region to a small height of the smaller region. Other tapering shapes are also possible.

The fixed waveguide 301 may include an array of waveguide branches such that the multiple microwave plasma gas chambers 104 may be used. In the example shown, there are four branches 301A-301D delivering microwave power to a respective four plasma chamber tubes 204. Although four branches and chamber are illustrated, other number of branches and chambers are possible based on the power supply capability and power needed to simultaneously sustain the respective plasmas among other things. Such an array can allow for one microwave generator to provide microwave radiation to generate multiple microwave plasmas. Particularly, when increasing the scale of microwave reactor systems, maintaining the plasma characteristics may be achieved by dividing microwave power into an array of generated plasmas. Without wishing to be bound by theory, increased plasma size may create less optimal plasma regions for a given vortex of gas (e.g., a large region of excessively heated gas or a region of plasma with substantially decreased flow) which may cause decreases in efficiency. These problems may be avoided by dividing microwave power into an array of generated plasmas.

With regard to the system of FIG. 3, as well as other systems described herein, any number of pumps 302, valves (not shown), and connections 209 may be used to adjust the pressure and flow of the component regions for efficient nitrogen fixation and production of desired products. Pumps 302 may be used to apply vacuum to microwave-plasma-gas-chamber 104 between 0-760 Torr, or more preferably, 1-300 Torr. Gas manifold 303 may allow for splitting or combining gas inputs and outputs to feed one or more microwave-plasma-gas chambers 104. Exemplary sensors for detecting microwave radiation, optical emission, temperature, pressure, and/or gas composition may be used and may be connected to a computer for adjusting the operational state of the system and its subcomponents.

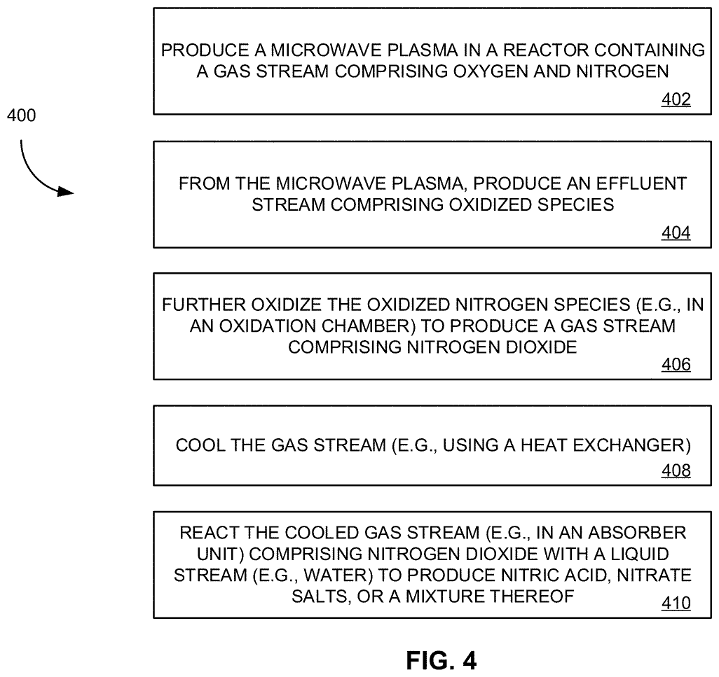

FIG. 4 is a flowchart of method 400 for operating a microwave plasma system, such as the microwave plasma system illustrated in FIGS. 1-3 and described above. One or more of the operations of method 400 may be performed by a computing device 106 in communication with one or more components of the plasma reactor, such as the microwave-power supply 101, microwave generator 102, the MW-plasma-gas chamber 104, chiller 105, gas separator 107, oxidation chamber 108, absorption unit 109, scrubber unit 110, or sensors on these components, and valves controlling feed gases. The operations may be executed through one or more software programs, one or more hardware components, or a combination of both hardware and software.

Beginning in operation 402, a microwave plasma 205 is produced in a reactor or MW-plasma-gas chamber 104 containing a gas stream comprising nitrogen and oxygen from gas input port 207. A gas injection system may be used and contain a gas separation system 107 or pumps 302 to inject this gas through port 207, as explained above. In operation 404, an effluent stream is produced comprising oxidized nitrogen species from an inlet stream comprising nitrogen and oxygen using microwave plasma 205 in MW-plasma-gas chamber 104. More or less microwave power and gas reactants may be supplied to take advantage of available power and optimize fixed nitrogen gas output efficiency. In operation 406, oxidized nitrogen species are further oxidized using oxidation chamber 108 to produce a gas stream comprising nitrogen dioxide in increased amounts. In one implementation, oxidation is increased by increasing dwell time in the oxidation chamber. In another implementation, oxidation is encouraged by changing the temperature of the oxidation chamber. Operation 408 cools the gas stream comprising nitrogen dioxide using a heat exchanger 208. In some implementations a heat exchanger 208 is combined with oxidation chamber 108 to save cost in the materials and operation. In one implementation, the cooling operation may be provided by one or more of chillers 105. In other implementations heat energy may be captured and released or used by other means, such as release to ambient air through a heat exchanger with metal fins. In some implementations, cooling the gas stream containing nitrogen dioxide allows for increased absorption in absorption unit 109. In operation 410, the gas stream comprising nitrogen dioxide is reacted with a liquid stream comprising water in an absorber unit to produce nitric acid, nitrate salts, or mixture thereof.

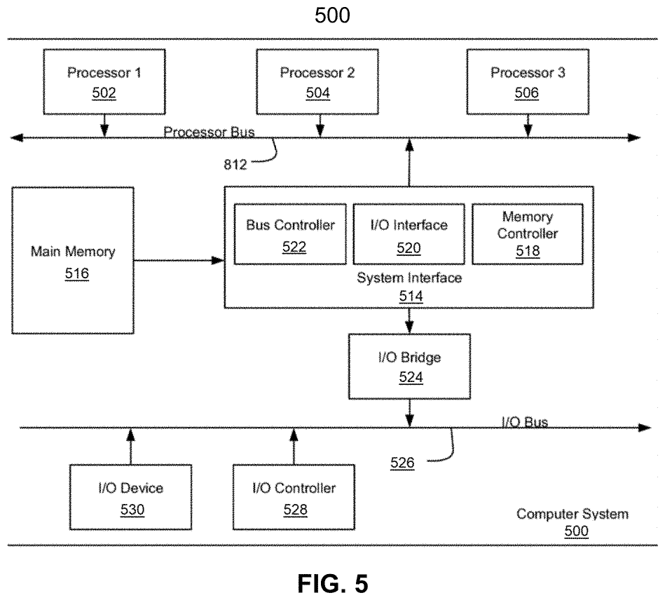

FIG. 5 is a block diagram illustrating an example of a computing device or computer system 500 which may be used in implementing the embodiments of the network disclosed above. In particular, the computing device of FIG. 5 is one embodiment of a computing device that performs one or more of the operations described above. The computer system (system) includes one or more processors 502-506. Processors 502-506 may include one or more internal levels of cache (not shown) and a bus controller or bus interface unit to direct interaction with the processor bus 512. Processor bus 512, also known as the host bus or the front side bus, may be used to couple the processors 502-506 with the system interface 514. System interface 514 may be connected to the processor bus 512 to interface other components of the system 500 with the processor bus 512. For example, system interface 514 may include a memory controller 518 for interfacing a main memory 516 with the processor bus 512. The main memory 516 typically includes one or more memory cards and a control circuit (not shown). System interface 514 may also include an input/output (I/O) interface 520 to interface one or more I/O bridges or I/O devices with the processor bus 512. One or more I/O controllers and/or I/O devices may be connected with the I/O bus 526, such as I/O controller 528 and I/O device 530, as illustrated.

I/O device 530 may also include an input device (not shown), such as an alphanumeric input device, including alphanumeric and other keys for communicating information and/or command selections to the processors 502-506. Another type of user input device includes cursor control, such as a mouse, a trackball, or cursor direction keys for communicating direction information and command selections to the processors 502-506 and for controlling cursor movement on the display device.

System 500 may include a dynamic storage device, referred to as main memory 516, or a random access memory (RAM) or other computer-readable devices coupled to the processor bus 512 for storing information and instructions to be executed by the processors 502-506. Main memory 516 also may be used for storing temporary variables or other intermediate information during execution of instructions by the processors 502-506. System 500 may include a read only memory (ROM) and/or other static storage device coupled to the processor bus 512 for storing static information and instructions for the processors 502-506. The system set forth in FIG. 8 is but one possible example of a computer system that may employ or be configured in accordance with aspects of the present disclosure.

According to one embodiment, the above techniques may be performed by computer system 500 in response to processor 504 executing one or more sequences of one or more instructions contained in main memory 516. These instructions may be read into main memory 516 from another machine-readable medium, such as a storage device. Execution of the sequences of instructions contained in main memory 516 may cause processors 502-506 to perform the process steps described herein. In alternative embodiments, circuitry may be used in place of or in combination with the software instructions. Thus, embodiments of the present disclosure may include both hardware and software components.

A machine-readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 516. Common forms of machine-readable medium may include, but is not limited to, magnetic storage medium; optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

While various aspects of the present disclosure are disclosed and described, it is to be understood that various aspects described herein are not limited to the particular example embodiments apparatus, methods, compositions, and/or materials disclosed herein, but is extended to equivalents thereof as would be recognized by those ordinarily skilled in the relevant arts. It should also be understood that terminology employed herein is used for the purpose of describing particular example embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.”The endpoint may also be based on the variability allowed by an appropriate regulatory body, such as the FDA, USP, etc.

Various modifications and additions can be made to the example embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment,” or similarly to an implementation, aspect or example, means that a particular feature, structure, or characteristic described in connection with the embodiment (implementation, aspect or example) is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

What is claimed:

1. A microwave-plasma system for generating fixed-nitrogen products comprising:
a microwave generator operably coupled with a gas chamber, the microwave generator providing microwave power to the gas chamber;
a source of gas operably coupled with the plasma chamber, the microwave power producing a plasma of the gas; and
an absorber unit fluidically connected to the gas chamber to capture product from the plasma in the gas chamber.

2. The microwave-plasma system according to claim 1 wherein the microwave generator comprises a magnetron head with a resonant cavity or a solid-state microwave generator, the microwave generator operably coupled with a waveguide operably coupled with the gas chamber.

3. The microwave-plasma system according to claim 1 wherein the gas chamber includes a tubular member and further comprising a waveguide operably coupled with the microwave generator, the waveguide defining a hole and further operably coupled with the tubular member at the hole to orient the waveguide perpendicular to a flow of gas in the tubular member thereby microwaves interface with a cross section of the flow of gas.

4. The microwave-plasma system according to claim 1 further comprising a power supply operably coupled with the microwave generator, the power supply providing pulsed or continuous power to the microwave generator.

5. The microwave-plasma system according to claim 1 where the source of gas comprises a source of oxygen and a source of nitrogen, the captured product includes fixed nitrogen gaseous products.

6. The microwave-plasma system according to claim 1 where the source of gas further comprises an air separation unit, the air separation unit delivering a stream of nitrogen and oxygen to the gas chamber.

7. The microwave-plasma system according to claim 1 further comprising an oxidation chamber oxidizing gaseous fixed-nitrogen products from the plasma chamber, the oxidation chamber coupled with the absorber unit and providing oxidized fixed-nitrogen products thereto.

8. The microwave-plasma system according to claim 1 wherein the absorber unit contains a salt or a basic compound to produce nitrate salts or the absorber unit contains water or hydrogen peroxide to produce nitric acid.

9. The microwave-plasma system according to claim 1 wherein the absorber unit captures gaseous fixed-nitrogen products as liquid fixed-nitrogen products.

10. The microwave-plasma system according to claim 1 wherein the absorber unit comprises one or more of a bubble-absorber column, a plate-absorber column, or a liquid-shower column.

11. A microwave-plasma system according to claim 1 further comprising an ignition system operably coupled with the plasma chamber, the ignition system igniting the plasma.

12. The microwave-plasma system according to claim 11 wherein the ignition system comprises a retractable conductive member with a non-conductive sheath.

13. The microwave-plasma system of claim 11 wherein the ignition system comprises a laser-ignition system, a noble-gas-injection-ignition system, a spark-ignition system, or an electric-field-pulse-ignition system.

14. A method for producing fixed-nitrogen products by microwave plasma oxidation of nitrogen, the method comprising:
generating and propagating microwaves into a plasma-generation chamber; and
feeding a gas comprising nitrogen and oxygen into the plasma-generation chamber in the presence of the microwaves thereby generating a plasma, wherein the plasma oxidizes the gas to produce oxidized nitrogen species;
wherein a conversion of nitrogen in the gas to oxidized nitrogen species is between about 0% to about 10%.

15. The method of claim 14, wherein the oxidized nitrogen species comprises one or more of nitric oxide, nitrogen dioxide, nitrous oxide, dinitrogen dioxide, nitric acid, and nitrous acid.

16. The method of claim 14, further comprising contacting the oxidized nitrogen species with a liquid.

17. The method of claim 14, wherein a concentration of nitrogen in the gas is between about 5% to about 85%.

18. The method of claim 14, wherein a concentration of oxygen in the gas is between about 5% to about 85%.

19. The method of claim 15, wherein a fraction of the nitric oxide in the oxidized nitrogen species is between about 40% to about 80% by volume.

20. The method of claim 15, wherein the nitric acid is captured with an efficiency of greater than about 80%.

21. The method of claim 14, wherein the gas is air.

22. The method of claim 14, wherein the gas further comprises argon.

23. A system for producing fixed nitrogen products by microwave plasma oxidation of nitrogen, the system comprising:
a gas inlet in communication with a plasma-generation chamber;
a microwave generator in communication the plasma-generation chamber producing microwaves to generate a plasma from a gas supplied to the plasma-generation chamber by way of the gas inlet;
a heat exchanger in fluid communication with the plasma-generation chamber;
an absorber in fluid communication with the heat exchanger, the absorber capturing oxidized nitrogen species in a liquid; and
a liquid-nitrate outlet in communication with the absorber.

24. The system of claim 23, wherein the gas comprises oxygen and nitrogen.

25. The system of claim 23, further comprising an oxidation chamber in communication with the plasma-generation chamber, the oxidation chamber further in fluid communication with the heat exchanger, the oxidation chamber oxidizing fixed nitrogen.

26. The system of claim 23, wherein the oxidized nitrogen species comprises nitric oxide, nitrogen dioxide, nitrous oxide, dinitrogen dioxide, nitric acid, and nitrous acid.

27. The system of claim 23, further comprising a recycle loop in fluid communication between the heat exchanger and the plasma-generation chamber.

28. The system of claim 23, further comprising a recycle loop in fluid communication between an input and an output of the absorber.

29. The system of claim 28, wherein the recycle loop recycles nitric oxide and nitrogen dioxide through the absorber.

30. The system of claim 27, wherein the recycle loop recycles reactants, N₂O, or argon to the plasma-generation chamber.
